(19) United States
(12) Patent Application Publication
(10) Pub. No.: US 2026/0312266 A1
(43) Pub. Date: Oct. 8, 2026

(54) BATTERY CELL

(71) Applicant: TOYOTA JIDOSHA KABUSHIKI KAISHA, Toyota-shi (JP)

(72) Inventors: Masahiro ISHIZUKA, Toyota-shi (JP); Atsushi SUGIHARA, Toyota-shi (JP); Satoshi NAKASHIMA, Toyota-shi (JP); Masato ONO, Nagoya-shi (JP); Masayoshi HAGA, Nagoya-shi (JP); Jun IZUMI, Toyota-shi (JP); Kenta MIYAHARA, Toyohashi-shi (JP)

(73) Assignee: TOYOTA JIDOSHA KABUSHIKI KAISHA, Toyota-shi (JP)

(21) Appl. No.: 19/456,110

(22) Filed: Jan. 22, 2026

(30) Foreign Application Priority Data
Apr. 2, 2025 (JP) 2025-061410

(51) Int. Cl. H01M 50/627; H01M 50/105

(52) U.S. Cl. CPC H01M 50/627; H01M 50/105

(57) ABSTRACT

The battery cell includes a battery body, a housing member that accommodates the battery body and the electrolyte solution, and an injection member. The housing member includes a first film portion that covers a first surface of the battery body, and a second film portion that covers a second surface of the battery body. The second surface is opposite the first surface. A welded portion at which the first film portion and the second film portion are welded together in a laminated state is provided adjacent to the battery body. An injection member extends from the interior to the exterior of the housing member through the interface between the first film portion and the first film portion at the welded portion. Inside the injection member, an injection port extending from the inside to the outside of the housing member is provided.

### CROSS-REFERENCE TO RELATED APPLICATION

This application claims priority to Japanese Patent Application No. 2025-061410 filed on Apr. 2, 2025. The disclosure of the above-identified application, including the specification, drawings, and claims, is incorporated by reference herein in its entirety.

### BACKGROUND

### 1.Technical Field

The technology disclosed in the present specification relates to battery cells.

### 2.Description of Related Art

Japanese Unexamined Patent Application Publication No. 2020-68197 (JP 2020-68197 A) discloses a battery cell including a battery body and a housing member. The housing member accommodates the battery body and an electrolyte solution. The housing member is formed of a film that covers the battery body. A welded portion at which the films are welded together is provided adjacent to the battery body. The housing member is sealed at the welded portion.

### SUMMARY

As described above, in the battery cell of JP 2020-68197 A, the housing member is sealed at the welded portion. This makes it difficult to inject an electrolyte solution into the housing member. The present specification proposes a technology that facilitates injection of an electrolyte solution into the housing member.

### FIRST ASPECT

A battery cell disclosed in the present specification includes: a battery body; a housing member that accommodates the battery body and an electrolyte solution; and an injection member. The housing member includes a first film portion that covers a first surface of the battery body, and a second film portion that covers a second surface of the battery body. The second surface is opposite the first surface. A welded portion at which the first film portion and the second film portion are welded together in a laminated state is provided adjacent to the battery body. The injection member extends from inside the housing member to outside the housing member through the interface between the first film portion and the second film portion at the welded portion. An injection port extending from inside the housing member to outside the housing member is provided inside the injection member.

With the above battery cell, an electrolyte solution can be easily injected into the housing member via the injection port.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a battery cell according to an embodiment;

FIG. 2 is a top view of a battery cell of an embodiment;

FIG. 3 is a cross-sectional view of a battery cell prior to sealing of a housing member; and

FIG. 4 is a cross-sectional view taken along line IV-IV in FIG. 2.

### DETAILED DESCRIPTION OF EMBODIMENTS

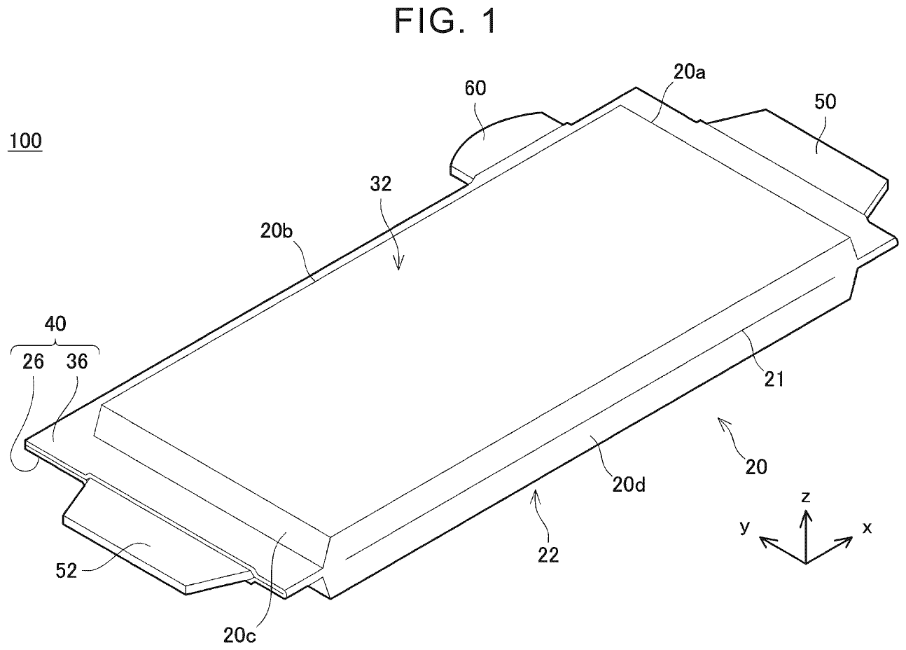

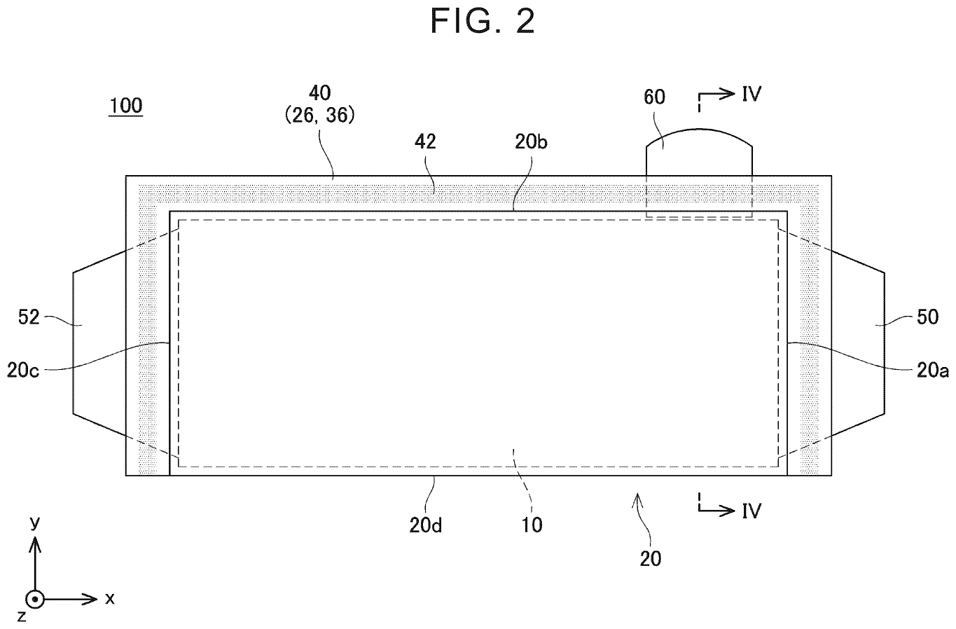

The battery cell 100 shown in FIG. 1 is mounted on, for example, a electrified vehicle. The battery cell 100 has a substantially rectangular plate shape. In the following description, the thickness direction of the battery cell 100 is referred to as the z-direction, the longitudinal direction of the battery cell 100 is referred to as the x-direction, and the width direction of the battery cell 100 (that is, the direction orthogonal to the z-direction and the x-direction) is referred to as the y-direction. When the battery cell 100 is used, a plurality of battery cells 100 is stacked in the z direction to form a battery module. As illustrated in FIG. 1, the battery cell 100 includes a housing member 20. As shown in FIG. 2, the battery body 10 is housed inside the housing member 20. The housing member 20 accommodates the battery body 10 and the electrolyte solution. An electrode plate 50 is provided at one end of the battery cell 100 in the x direction, and an electrode plate 52 is provided at the other end of the battery cell 100 in the x direction. The electrode plate 50 is a positive electrode, and the electrode plate 52 is a negative electrode.

The battery body 10 is a battery that can be repeatedly charged and discharged.

As shown in FIG. 2, the battery body 10 has a substantially plate shape. The battery body 10 is a laminate in which a plurality of positive electrode current collector foils and a plurality of negative electrode current collector foils are alternately arranged in the z direction via a separator. Although not shown, a positive electrode collector foil portion in which positive electrode collector foils are bundled is provided at one end portion of the battery body 10 in the x direction. An electrode plate 50 is connected to the positive electrode collector foil portion. Further, although not shown, a negative electrode collector foil portion in which the negative electrode collector foil is bundled is provided at the other end portion of the battery body 10 in the x direction. An electrode plate 52 is connected to the negative electrode collector foil portion. The battery body 10 is immersed in an electrolyte solution filled in the housing member 20.

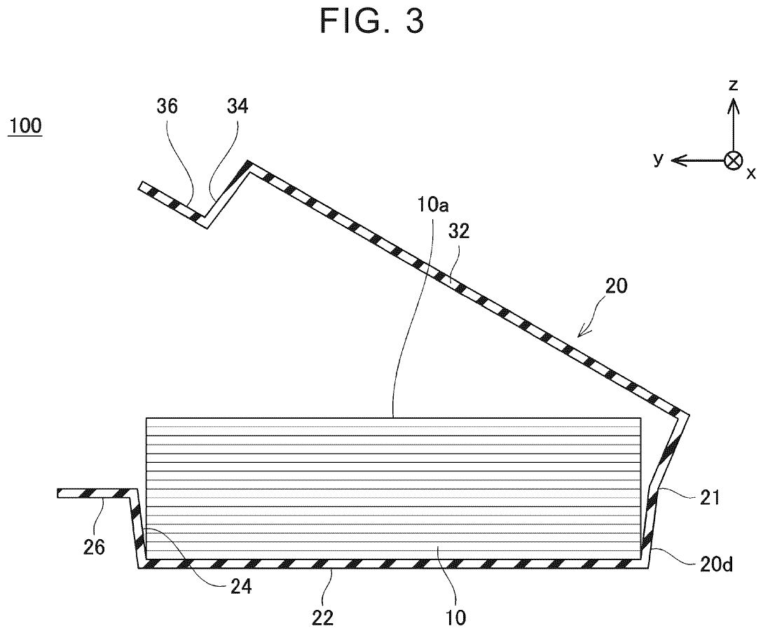

FIG. 3 is a cross-sectional view of the battery cell 100 before sealing the housing member 20. As shown in FIG. 3, the housing member 20 is formed of a film. As the film constituting the housing member 20, for example, a laminate film in which a resin coating layer is provided on both surfaces of an aluminum film can be used. The film constituting the housing member 20 is formed into a container shape having the first film portion 22 and the second film portion 32 by embossing. A fold 21 is provided on a side surface of the housing member 20. The second film portion 32 can swing with respect to the first film portion 22 about the fold 21.

The first film portion 22 includes a housing portion 24 and a frame portion 26.

The housing portion 24 has a cup shape having a recessed portion capable of accommodating the battery body 10. A lower portion of the battery body 10 is accommodated in the housing portion 24. The frame portion 26 is provided around the housing portion 24. The second film portion 32 includes a housing portion 34 and a frame portion 36. The housing portion 34 has a cup shape having a recessed portion capable of accommodating the battery body 10. The frame portion 36 is provided around the housing portion 34. When the housing member 20 is closed, the upper surface 10a of the battery body 10 is covered by the housing portion 34. Further, when the housing member 20 is closed, the frame portion 36 overlaps the frame portion 26. Hereinafter, a portion where the frame portion 36 and the frame portion 26 overlap is referred to as a laminated portion 40. As shown in FIGS. 1 and 2, the housing member 20 has a side surface 20a to 20d. The side surface 20a, 20c is a side surface of the housing member 20 extending in the lateral direction. The side surface 20b, 20d is a longitudinally extending side surface of the housing member 20. The above-described fold 21 is provided on the side surface 20d. The laminated portion 40 is provided on the side surface 20a to 20c. The laminated portion 40 protrudes from the side surface 20a to 20c.

As shown in FIGS. 1 and 2, the electrode plates 50, 52 extend from the battery body 10 to the outside of the housing member 20. The electrode plate 50 extends from the inside to the outside of the housing member 20 through the interface between the frame portion 26 and the frame portion 36 in the laminated portion 40 provided on the side surface 20a. The electrode plate 52 extends from the inside to the outside of the housing member 20 through the interface between the frame portion 26 and the frame portion 36 in the laminated portion 40 provided on the side surface 20c.

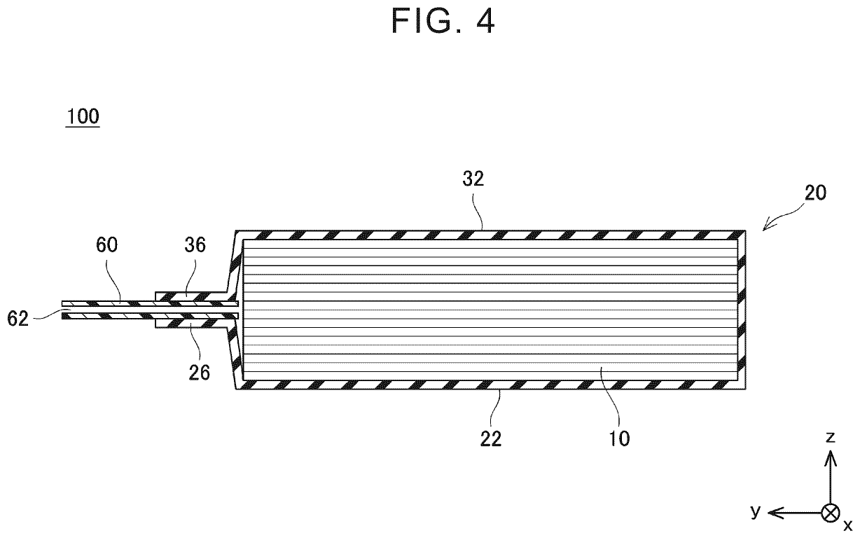

The battery cell 100 includes an injection member 60. The injection member 60 is a resin component. The injection member 60 extends from the inside to the outside of the housing member 20 through the interface between the frame portion 26 and the frame portion 36 in the laminated portion 40 provided on the side surface 20b. Note that the injection member 60 may be provided on the side surface 20a or the side surface 20c. As shown in FIG. 4, an injection port 62 is provided inside the injection member 60. The injection port 62 extends from the inside to the outside of the housing member 20. A leak prevention mechanism such as a valve or a plug is provided in the injection port 62 so that the electrolyte solution inside the housing member 20 does not leak.

In FIG. 2, the dot-hatched region is the welded portion 42. The welded portion 42 is provided in the laminated portion 40. In the welded portion 42, the lower surface of the frame portion 36 (that is, the inner surface of the housing member 20) and the upper surface of the frame portion 26 (that is, the inner surface of the housing member 20) are thermally welded. As shown in FIG. 2, when viewed along the z-direction, the welded portion 42 extends along the outer periphery of the laminated portion 40. When viewed along the z-direction, the welded portion 42 extends linearly across the electrode plates 50, 52 and the injection member 60. In a region of the welded portion 42 where the electrode plates 50, 52 and the injection member 60 do not exist, the frame portion 36 is welded to the frame portion 26. In a region of the welded portion 42 where the electrode plate 50 is present, the frame portion 26 is welded to the lower surface of the electrode plate 50, and the frame portion 36 is welded to the upper surface of the electrode plate 50. In a region of the welded portion 42 where the electrode plate 52 is present, the frame portion 26 is welded to the lower surface of the electrode plate 52, and the frame portion 36 is welded to the upper surface of the electrode plate 52. In a region of the welded portion 42 where the injection member 60 is present, the frame portion 26 is welded to the lower surface of the injection member 60, and the frame portion 36 is welded to the upper surface of the injection member 60. Since the housing member 20 is sealed in the welded portion 42, leakage of the electrolyte solution in the housing member 20 is prevented.

Next, the function of the injection member 60 will be described. The use of the battery cell 100 may degrade the functionality of the battery cell 100 due to aging. In this case, the maintenance worker or the like can inject the electrolyte solution from the outside of the housing member 20 into the inside via the injection port 62 of the injection member 60. Accordingly, the function of the battery cell 100 can be restored.

During charging and discharging of the battery cell 100, gas is generated from the electrolyte solution. The generation of the gas may increase the internal pressure of the housing member 20. In this case, the maintenance worker or the like can discharge the gas in the housing member 20 to the outside of the housing member 20 via the injection port 62 of the injection member 60. Accordingly, an excessive increase in the internal pressure of the housing member 20 can be prevented.

While the embodiments have been described in detail above, these are merely illustrative and do not limit the scope of the claims. The technology described in the claims includes various modifications and alterations of the specific examples described above. The technical elements described in this specification or in the drawings may be used alone or in various combinations, and are not limited to the combinations described in the claims at the time of filing. Further, the technology illustrated in the present specification or the drawings achieves a plurality of objects at the same time, and has technical usefulness by achieving one of the objects.

What is claimed is:

1. A battery cell comprising:
a battery body;
a housing member that accommodates the battery body and an electrolyte solution; and
an injection member, wherein:
the housing member includes
a first film portion that covers a first surface of the battery body, and
a second film portion that covers a second surface of the battery body, the second surface being opposite the first surface;
a welded portion at which the first film portion and the second film portion are welded together in a laminated state is provided adjacent to the battery body;
the injection member extends from inside the housing member to outside the housing member through an interface between the first film portion and the second film portion at the welded portion; and
an injection port extending from inside the housing member to outside the housing member is provided inside the injection member.
